(19) United States
(12) Patent Application Publication
(10) Pub. No.: US 2010/0046590 A1
(43) Pub. Date: Feb. 25, 2010

(54) EXTENDING TRANSMISSION DISTANCE IN A HIGH-SPEED SERIAL NETWORK

(75) Inventors: Michael L. Harper, Tucson, AZ (US); Craig A. Klein, Tucson, AZ (US); Gregg S. Lucas, Tucson, AZ (US); Mary Anne Marquez, Tucson, AZ (US); Robert E. Medlin, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/194,196

(22) Filed: Aug. 19, 2008

(51) Int. Cl. H04B 3/36

(52) U.S. Cl. 375/211

(57) ABSTRACT

A data transmission system for transmitting data from a first location to a second location includes a transmitting device configured to transmit the data and located at the first location. The transmitting device includes a serial attached SCSI (SAS) enabled controller. The system also includes an I/O port coupled to the transmitting device and having multiple lanes and a repeater powered by one of the lanes. The system also includes a receiving device coupled to the second end of the cable.

### BACKGROUND

The present invention relates to cables, and more specifically, to high-speed serial cables.

Today's most popular high-speed serial networking interfaces such as Ethernet and Fiber Channel provide for long distance data transmission. Distances of kilometers are achievable and were key to wide spread usage and adoption of these technologies for most practical applications.

Serial Attached SCSI (SAS) is a new technology, which today is only defined and applied to relatively short distances, such as meters or perhaps tens of meters at best. Serial Attached SCSI (SAS) is a data transfer technology designed to move data to and from computer storage devices such as hard drives and tape drives. It is a point-to-point serial protocol that replaces the parallel SCSI bus technology that first appeared in the mid 1980s in corporate data centers, and uses the standard SCSI command set.

A SAS cable supports the differential signals specified by the SAS protocol by providing a differential pair for each transmission direction. That is, each connection, or “lane,” includes four wires, a pair of transmit wires (transmit (+) and transmit (−)) and a pair of receive wires (receive (+) and receive (−)). At present, multiple lanes may be coupled into a single “wide port” to increase the bandwidth.

At present, no sideband signals have been defined for the standard SAS interfaces. Certainly, to exploit SAS technology, increased transmission distances must be achieved.

### SUMMARY

According to one embodiment of the present invention, data transmission system for transmitting data from a first location to a second location is disclosed. The system of this embodiment includes a transmitting device configured to transmit the data and located at the first location. The transmitting device includes a serial attached SCSI (SAS) enabled controller configured to receive a first input stream, a second input stream, a third input stream and fourth input stream and to multiplex the first and second input streams to create a combined input stream. The transmitting device further includes a power supply. The transmitting device transmits the combined input stream at 6 GB/s and transmits the third and fourth input streams at 3 GB/s. The system of this embodiment also includes an I/O port coupled to the transmitting device and having a first lane input, a second lane input, a third lane input and a fourth lane input, wherein the combined input stream is coupled to the first lane input, the third input stream is coupled to the second lane input, the fourth input stream is coupled to the third lane and power supply is coupled to the fourth lane. The system of this embodiment also includes a cable having a first end and a second end, the first end being coupled to the I/O port, the cable including a first cable lane, a second cable lane, a third cable lane and a fourth cable lane, each lane comprising four wires which collectively form a transmit and receive differential pairs. The cable further includes a repeater configured to repeat the combined input stream, the third input stream and the fourth input stream and receiving power from the fourth lane. The system also includes a receiving device coupled to the second end of the cable.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows a system according to one embodiment of the present invention;

FIG. 2 shows an example of a cable according to one embodiment of the present invention; and

FIG. 3 is a flow chart depicting a method according to an embodiment of the present invention.

### DETAILED DESCRIPTION

Embodiments of the present invention are directed to wide SAS port cabled interfaces. A typical wide port consists of 4 SAS lanes, each lane being a high speed serial interface, that can transfer 4 different input/output (I/O) streams concurrently. According to the present invention, SAS multiplexing (as defined by the SAS protocol) is utilized such that at least one of the 4 lanes is time multiplexed with another lane within the group of four. This frees up a lane that can be used to provide power to a cable. The cable includes active circuitry (powered by the “free lane”) forming a repeater that re-drives the I/O streams. Re-driving the signal allows for greater cable length to be achieved. In some embodiments, re-drive (repeater) electronics may be tuned to the cable characteristics and length.

In more detail, utilizing the SAS (6 Gb/s) multiplexing function that is standardized and implemented today, in conjunction with wide (multi lane) SAS ports, a method and implementation combines both multiplexing and wide port functions resulting in the ability to extend the transmission distance over copper cables. In one embodiment, a 4 lane wide port which normally runs at 3 Gb/s is implemented. Two of the four lanes are multiplexed together and the resulting lane is run at 6 Gb/s, leaving one lane unused, while still achieving the desired transmission bandwidth. Within the cable there are one or more repeaters that re-drive the signals.

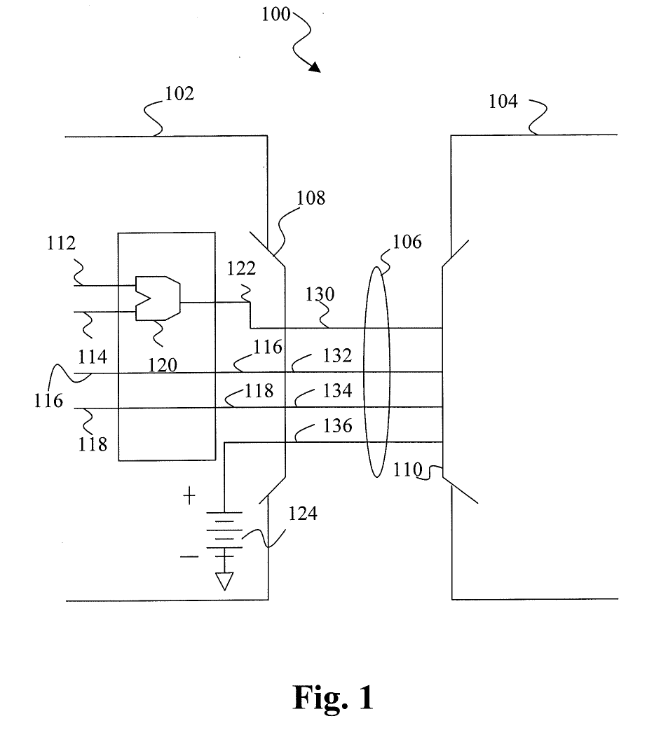

FIG. 1 shows an example of a system 100 according to one embodiment of the present invention. The system includes a transmitting device 102 and a receiving device 104. The transmitting device 102 and receiving device 104 may be any type of computing devices. In one embodiment, the transmitting device is a computer such as a mainframe computer, server, or a collection of coupled mainframes or servers. In one embodiment, the receiving device 104 is a computer storage device such as a hard drive or a tape drive.

The transmitting device 102 is coupled to the receiving device 104 by a cable 106. The cable 106 is a specialized cable according to one embodiment of the present invention. In one embodiment, the cable 106 includes four lanes. At least one of the lanes, however, is devoted to carrying power to re-drive circuitry disposed in the cable. As shown, the cable includes four lanes, a first lane 130, a second lane 132, a third lane 134 and a fourth lane 136.

The transmitting device 102 includes an I/O port 108 and the receiving device 104 includes an I/O port 110. These I/O ports are, in one embodiment, standard wide port SAS I/O ports where multiple lanes may be clustered to increase bandwidth between the transmitting device 102 and the receiving device 104.

The transmitting device 102 may include four or more input streams. As shown, the input streams shown are a first input stream 112, a second input stream 114, a third input stream 116, and a fourth input stream 118. The input streams contain information that is to be transmitted to the receiving device 104. Of course, given the two-way nature of the communications between the devices, the same or similar components may also exist in the receiving device 104 as in the transmitting device 102.

The transmitting device 102 may include a SAS enabled controller 110. The SAS enabled controller 110 formats input streams into transmission streams for transmission over the cable 106 to the receiving device 104. In one embodiment, the transmission streams are typically transmitted at a rate of 3 GB/s. However, in this embodiment, the SAS enabled controller 110 may be configured to multiplex two of the input streams according to the SAS protocol and transmit the signal at 6 GB/s. In one embodiment, this may be done in software. In another embodiment, a physical multiplexer 120 may be included in the system. Regardless, the operations of the multiplexer 120 intermixes, according to the SAS protocol, the first input signal 112 and the second input signal 114 together with a 50% duty cycle. Of course, other mixing protocols could be implemented. In one embodiment, the combined signal is output at rate of 6 GB/s and is shown as combined stream 122 in FIG. 1. The remaining two input signals are, in one embodiment, simply transmitted on without change (except for possible format requirements).

Given that the first input stream 112 and the stream input signal 114 have been multiplexed to form combined stream 122 and streams 116 and 118 are essentially the same, what began as four input streams is now three steams. In one embodiment, the combined stream is transmitted on the first lane 130, the third stream 116 is transmitted on the second lane 132, and the fourth stream 118 is transmitted on the third lane 134. Thus, all of the streams, according to the present invention may be transmitted on fewer than all of the lanes provided by the cable 106.

The “extra” or “free” lane (the fourth lane 136) is used, in one embodiment, to carry power to re-drivers contained in the cable 106 which re-drive the streams in the first, second and third lanes, 130, 132 and 134, respectively, to allow for longer transmission distances. To that end, the transmitting device 102 may include a power supply 124 coupled to the fourth lane 136. Of course, in one embodiment, the SAS enabled controller 120 may be configured to multiplex the third input stream 116 and the fourth stream 118 together to free up another lane so more power may be transmitted.

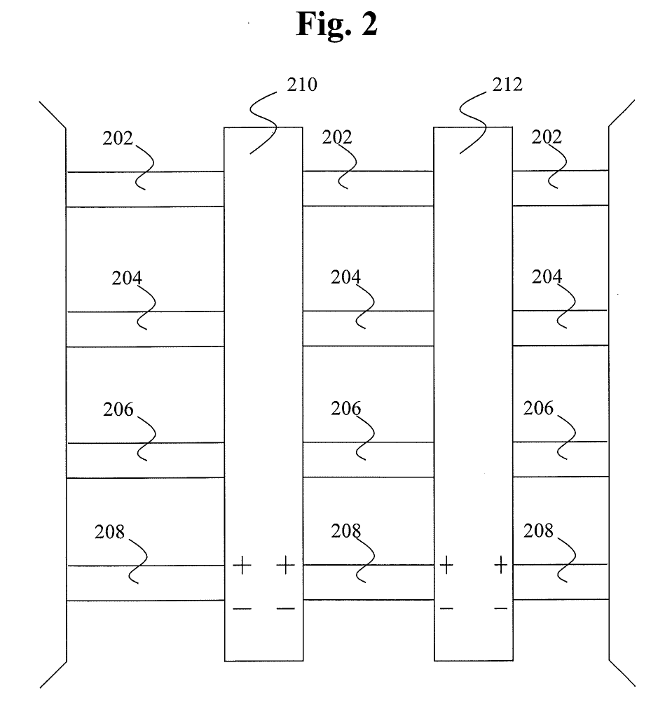

FIG. 2 shows an example of a cable 200 according to an embodiment of the present invention. The cable includes at least four lanes but may include more. As shown, the cable includes a first lane 202, a second lane 204, a third lane 206 and a fourth lane 208. Each lane contains four wires to provide for the transmission and reception of differential signals. In particular, each lane includes a pair of transmit wires (transmit (+) and transmit (−)) and a pair of receive wires (receive (+) and receive (−)). In one embodiment, each wire is made of copper but other metals may be used.

The cable 200 includes a first re-driver 210 and a second re-driver 212. In one embodiment, the first re-driver 210 redrives “transmit” signals and the second re-driver 212 redrives “receive” signals. Re-drivers are also referred to herein as repeaters. In one embodiment, the first re-driver 210 is powered by a power supply in a first device (i.e., a transmitter) and the second re-driver 212 is powered by a power supply in a second device (i.e., a receiver). The power is transmitted over the fourth lane 208 in this embodiment. Of course, the power could be transmitted over any “free” lane. That is, the power could be transmitted over any lane not being used to transmit information.

The number of re-drivers contained in the cable 200 is not limited to two. In one embodiment, only one re-driver may be included. In other embodiments, more than two re-drivers are included. The re-drivers (or repeaters) may be formed by any prior art electronic device that receives a signal and retransmits it at a higher level and/or higher power, so that the signal can cover longer distances without degradation. In one embodiment, the repeater is matched to the particular cable in which it is resident. In one embodiment, multiple cables may be joined together.

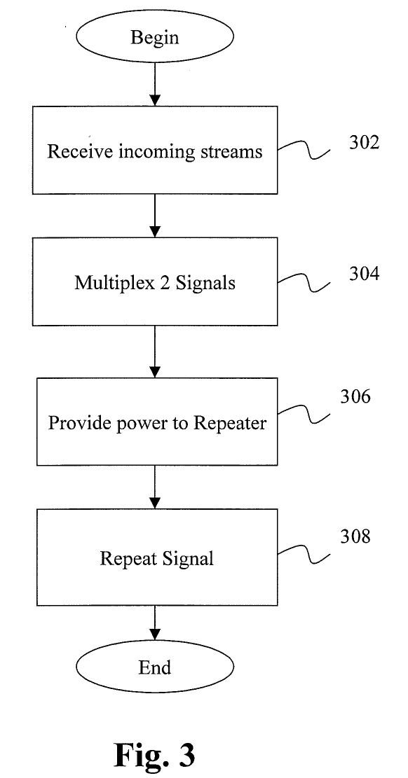

FIG. 3 shows a method according to one embodiment of the present invention. At a block 302, incoming data streams are received. The streams may be received, for example, at a SAS enabled controller implementing the SAS protocol. Of course, the streams may be received as data, that is assembled into streams by the SAS enabled controller. In one embodiment, four streams are received/created.

At a block 304, two of the streams are multiplexed together. In one embodiment the two multiplexed streams are output as a signal stream at twice the rate as the other two streams. In one embodiment, the multiplexed streams are output at 6 GB/s while the other two streams are output at 3 GB/s. In one embodiment, the two streams are multiplexed in such a manner that for a first time period the first stream is transmitted and for a second, equal time period, the second stream is transmitted. The length of the time period is variable.

At a block 306, power is provided to a repeater that is powered. Powering the repeater is described in greater detail above. In general, however, delivering power to the repeater includes coupling a power supply to a lane that is now free due to multiplexing of two of the input streams together to form a single stream.

At a block 308, a signal received at the powered repeater is repeated though the cable in which the repeater is located. In this manner, the distance a stream (signal) may travel is increased.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A data transmission system for transmitting data from a first location to a second location, the system comprising:
a transmitting device configured to transmit the data and located at the first location, the transmitting device including a serial attached SCSI (SAS) enabled controller configured to receive a first input stream, a second input stream, a third input stream and fourth input stream and to multiplex the first and second input streams to create a combined input stream, the transmitting device further including a power supply, wherein the transmitting device transmits the combined input stream at 6 GB/s and transmits the third and fourth input streams at 3 GB/s;
an I/O port coupled to the transmitting device and having a first lane input, a second lane input, a third lane input and a fourth lane input, wherein the combined input stream is coupled to the first lane input, the third input stream is coupled to the second lane input, the fourth input stream is coupled to the third lane and power supply is coupled to the fourth lane;
a cable having a first end and a second end, the first end being coupled to the I/O port, the cable including a first cable lane, a second cable lane, a third cable lane and a fourth cable lane, each lane comprising four wires which collectively form a transmit and receive differential pairs, the cable further including a repeater, the repeater configured to repeat the combined input stream, the third input stream and the fourth input stream and receiving power from the fourth lane; and
a receiving device coupled to the second end of the cable.
